(19) United States
(12) Patent Application Publication
(10) Pub. No.: US 2017/0008558 A1
(43) Pub. Date: Jan. 12, 2017

(54) ARRANGEMENT FOR CONNECTING CHASSIS COMPONENTS AND WHEEL CARRIERS FOR MOTOR VEHICLES

(71) Applicant: ZF FRIEDRICHSHAFEN AG, Friedrichshafen (DE)

(72) Inventors: Sven Philip KRÜGER, Würzburg (DE); Andreas VÄTH, Schweinfurt (DE); Hendrik MARQUAR, Schweinfurt (DE); Josef RENN, Dettelbach (DE); Sven GREGER, Bergrheinfeld (DE); Edmont HOFMANN, Niederwerrn (DE)

(21) Appl. No.: 15/117,740

(22) PCT Filed: Jan. 12, 2015
(86) PCT No.: PCT/EP2015/050383

§ 371 Date: Aug. 10, 2016

(30) Foreign Application Priority Data
Feb. 13, 2014 (DE) 10 2014 202 628.8

(51) Int. Cl. B62D 7/18; F16C 11/06; B60G 7/00; F16B 5/02

(52) U.S. Cl. CPC B62D 7/18; F16B 5/02; F16C 11/0604; F16C 11/0695; B60G 7/005; B60G 7/008; B60G 2204/14; B60G 2204/416; B60G 2204/4402; B60G 2206/50; B60G 2206/7101; B60G 2206/8207; B62D 7/166

(57) ABSTRACT

An arrangement for connecting chassis parts, in particular a screw connection, between a structure made of a fiber-plastic composite and a metallic load-introducing element, designed as a traction member. The structure is double-walled having a first wall and at least a second wall spaced from the first wall. The first and second walls have each coaxially positioned recesses and a spacer, having a through hole, is positioned between the first and second walls. The load-introducing element extends through at least one recess and the hole of the spacer. The load-introducing element has a holding part assigned to it, and the load-introducing element and the holding part are connected to one another by a connecting segment. The connecting segment and/or the holding part essentially pass through the first and/or the second wall.

This application is a National Stage completion of PCT/EP2015/050383 filed Jan. 12, 2015, which claims priority from German patent application serial no. 10 2014 202 628.8 filed Feb. 13, 2014.

### FIELD OF THE INVENTION

The invention concerns an assembly for connecting chassis components, in particular screw connections, between a structure of a fiber-plastic-composite (FPC) and a metallic load-introducing element, in particular designed as a traction member. The invention concerns also a wheel carrier for motor vehicle with an at least double-walled structure made from fiber-plastic-composite.

### BACKGROUND OF THE INVENTION

The term fiber-plastic-composite, abbreviated FPC, is meant to be plastic material which comprises a textile with long or endless fibers, for instance of glass or carbon, and on the other hand a matrix component which combines the fibers, for instance a resin. Instead of the term fiber-plastic-composite, the technical literature also uses the term fiber-composite- plastic, abbreviated as FOP. Such plastic material is characterized by a relatively low weight at a high strength and is increasingly applied in the construction of motor vehicles. Hereby, the problem occurs to connect the FPC structure with other parts, for instance load-introducing devices metallic based materials, in a way that the different material characteristics of plastic and metal are sufficiently considered.

Through the publication DE 10 2007 053 120 A1, a wheel carrier for a motor vehicle is known, where its structure comprises a fiber composite material and which has several load-introducing elements. Herein, the load-introducing elements can be understood as being the support of a spring strut or the mounting of a joint bearing for a steering arm. The basic structure of the known wheel carrier is designed in a tub shape and comprises of a single deformed plastic wall. For the mounting of load-introducing elements, for instance steering arms, preferably recesses are provided in the plastic wall.

### SUMMARY OF THE INVENTION

It is an object of the present invention to reliably connect plastic structures, in particular made of fiber-plastic-composite, material appropriately with a load-introducing element which is in particular made of metal.

Furthermore, it is an object of the invention to connect a fiber-plastic-composite structured wheel carrier with a metallic load-introducing element.

The objectives of the invention are solved through the characteristics of the independent claims. Advantageous embodiments result from the independent claims.

In accordance with the invention, an assembly is created to connect chassis components between a structure of fiber-plastic-composite (FPC) and a metallic, in particular designed as traction element, load-introducing element, whereby the structure is designed as multi-walled, in particular double-walled, and which has a first wall whereby the first and the additional wall each have coaxially positioned recesses. The configuration further comprises that, between the first and the additional wall, a spacer with a through hole is positioned, whereby the load-introducing element extends at least into a recess and the through hole of the spacer. Hereby, the through hole can be manufactured through cutting, or erosion, or as a highly accurate fitting. The load-introducing element has an assigned holding element, whereby the load-introducing element and the holding element are connected with each other through a connecting segment, in particular as form-fit, friction -fit, and/or material fit, and whereby the connecting segment and/or the holding element are essentially passing through the first and/or the at least additional, second wall. The connecting segment can be designed as a threaded segment. In that case, the load-introducing element and the holding element have inner or outer threads, respectively, so that these parts can be screwed together with each other.

Thus and in a first aspect of the invention, an assembly is hereby provided for the connection of chassis components with a load-introducing element and a holding element, whereby the load-introducing element and the holding element are connected with each other through a connecting section which is essentially positioned within the outer contours of the at least double-walled structure. On one hand, a construction space advantage is achieved, not only that the elements of the connecting assembly, in particular the holding element, do not essentially extend beyond the outer contour, but they are positioned within the multi-walled structure. Thus, the neighboring construction space at the outer contour of the structure can be used for other parts. Due to the multi-walled structure, comprising of a first and at least an additional, second wall positioned in a distance, the advantage is created that introduced torques and/or tension or compression forces, respectively, through the load-introducing element are accommodated by a force coupling, whereby in one wall mainly tensile forces occur and in an additional or other wall mainly compression forces occur. Bending stress, which it is especially damaging to a plastic structure, is therefore avoided. The load-introducing element is preferably designed as a tension member. In the structure which is made of fiber-plastic-composite, through holes are also provided to extend the holding element or the load-introducing element. These can be machined in. It is also possible that the through holes for the intended chassis component are created during production of the fiber-plastic composite by widening or spiking of the fiber material. It means that the fiber fabric, at the required locations for the through holes and prior to adding the plastic (for instance resin), is widened by a conical part, for instance a pin or a cone. it is hereby avoided that the fiber is cut in the area of the through hole, as it occurs in a machined through hole.

In a preferred embodiment, the holding element is designed as a threaded sleeve which supports itself, directly or indirectly, in reference to the first wall and which extends with its threaded section into the space between the first and the second wall. Thus, a relatively flat outer contour of the first wall is created. The connection section is preferably form-fit designed as a threaded/screwed connection. Alternatively, a material-fit connection in form of a glued connection or welded connection can be selected.

In an additional, preferred embodiment, the holding element is designed as an embedded nut, meaning that the nut, in reference to the outer contour of the first wall, is buried in the space between the first and the at least second wall. The countersunk nut supports itself hereby in reference to the first wall.

In an additional, preferred embodiment, the holding element is designed as a cylinder head screw, preferably with an Allen or hexagonal socket, with the cylinder head screw indirectly supported relative to the first wall. Hereby, a flat outer contour is also created.

In an additional, preferred embodiment, the load-introducing element is designed as a ball stud, whereby the ball head is positioned at the outside of the outer contour of the second wall and where it is part of an articulatable ball joint through which transverse forces can be introduced into the at least double-walled structure.

In an additional, preferred embodiment, the ball stud has a substantially conical shaft or a cylindrical shaft. Thus, there is a possibility for a free of play, force or friction fit, respectively, accommodation in a respective tapered sleeve.

In an additional, preferred embodiment, in particular the conical shaft (outer cone) of the ball stud is positioned in the recess, in particular the inner cone of a cone sleeve, where it is friction-fit supported under tensile loading. Radial and axial forces which act on the ball stud from the outside are therefore introduced free of play through the cone sleeve in the at least double-walled structure.

In an additional preferred embodiment the holding element, in particular the threaded sleeve or the countersunk nut, has an inner thread while the bail stud has an outer thread at its end. The inner and the outer threads create, positioned inside of the double-walled structure, the connection segment, in particular the threaded segment. Hereby, space is gained in reference to the tension direction.

In an additional, preferred embodiment, a blind hole with a polygonal cross-section is positioned in the load-introducing element, in particular the traction part, preferably in the ball stud and either in the end of the ball stud or the end of the thread. Preferably the blind hole has an inner hexagon or a hexagonal cross section so that, by means of a suitable installation tool, torque can be created at the traction member part for the purpose of a screw connection with the holding element. A construction space gain is hereby achieved in the tension direction, meaning in the longitudinal direction of the ball stud.

In an additional, preferred embodiment, the holding element and in particular the threaded sleeve, has a collar which is supported directly or indirectly in reference to the first wall. The tension force which results from the ball stud is hereby transferred through the collar of the threaded sleeve to the outer surface of the first wall.

In an additional, preferred embodiment, the countersunk nut is indirectly supported in reference to the first wall through a collar sleeve, meaning that the countersunk nut supports itself on the collar sleeve and the hollow sleeve supports itself in reference to the first wall, which also creates a flat construction method. The countersunk nut can be tightened or loosened by means of a socket wrench.

In an additional, preferred embodiment, the cylinder head screw which is designed as the holding element, has an outer thread and the ball stud which is designed as the traction member has an inner thread which creates with the outer thread of the cylinder head screw, the threaded section which is positioned within the double-walled structure. The head of the cylinder head screw is almost completely countersunk in reference to the outer contour of the first wall.

In an additional, preferred embodiment, a first disc with a micro-toothed surface is positioned between the collar of the threaded sleeve, which is designed as the holding element, and the first wall and which presses into the first wall which has a softer surface. Hereby the advantage of an increase of the friction coefficient between metal and plastic is achieved. Micro toothed surfaces are already known, for instance from “Konstruktion 2013”, page 62-65 (H.Schürmann, H.Elter: Beitrag zur Gestaltung von Schraubverbindungen bei Laminaten aus Faser-Kunststoff-Verbunden), In the case of the preferred screw connection, the increase of the friction coefficient creates an increase of the friction (parallel to the wall surface) so that, during the same preload force of the traction member, a larger force couple is available for accommodating the load torque which is initiated from the outside.

In an additional, preferred embodiment, the conical sleeve has a collar which is supported relative to the second wall. Thus, axial forces of the ball stud, especially resulting from the preload with the holding element, are transferred to the second wall through the collar of the cone sleeve.

In an additional, preferred embodiment, a second disc with a micro-toothed surface is positioned between the collar of the cone sleeve and the second wall. Thus, the resulting friction force also creates an increase of the friction coefficient at the outer surface of the second wall, so that a larger force couple counteracts the load torque. Altogether, the load torque which is introduced through the ball stud into the multi-walled, in particular double-walled, structure is transferred by either friction-fit or also by form-fit, whereby the form-fit functions as a quasi reserve or safety, respectively, if the friction-fit fails (changes from static friction to sliding friction).

In an additional, preferred embodiment, the countersunk cylinder head screw is supported by a collar sleeve with respect to the first wall, meaning indirectly. The cylinder head screw is supported with respect to a collar of the collar sleeve, and the collar sleeve is supported by a second collar with respect to the first wall. A low profile construction is hereby achieved, which also needs little construction space from the radial view point.

In an additional, preferred embodiment, the holding element, in particular the collar of the threaded sleeve, has surfaces or openings, where at the perimeter or in its opening or recesses, respectively, a form-fit mounting tool can be applied to, whereby the mounting tool, in particular exclusively, is used for the installation and the creation of the preload for the screw connection.

In a second aspect of the invention, load elements are attached to a wheel carrier for motor vehicles, in a fiber-plastic-composite construction, by means of the inventive configuration for a connection of chassis components, in particular a screw connection. It is hereby preferably a wheel carrier and is in accordance with an older application by the applicant with the official file number DE 10 2013 209 987.8, and the contents of which are fully incorporated by reference thereto, into the disclosure of the present application. The wheel carrier in the old the application has a first shell, designed as inner shell, and at least an additional, second outer shell, designed as a wall so that a multi-walled, in particular in double-walled structure is created, and to which by means of the configuration for the connection of chassis components, in particular screw connection, load-introducing elements, preferably metallic ball studs can be attached. A control arm and a steering rod are preferably attached to the ball stud and which introduce lateral forces or torques, respectively, into the structure of the wheel carrier. Due to the inventive connection, in particular the screw connection, the FPC structure of the wheel carrier is hereby relatively minimally stressed and minimally deformed.

### BRIEF DESCRIPTION OF THE DRAWINGS

Embodiment examples of the invention are presented in the drawings and described in more detail below and from which further characteristics and/or advantages can result. These show:

FIG. 1 a first embodiment example of the invention for a school connection between a FPC structure and a ball stud,

FIG. 2 a second embodiment example for a screw connection.

FIG. 3 a third embodiment example for a screw connection,

FIG. 4 a fourth embodiment example for a screw connection,

FIG. 5 a fifth embodiment example for a school connection, and

FIG. 6 a wheel carrier in a FPC construction with the screw connection.

### DETAILED DESCRIPTION OF THE PREFERRED EMBODIMENTS

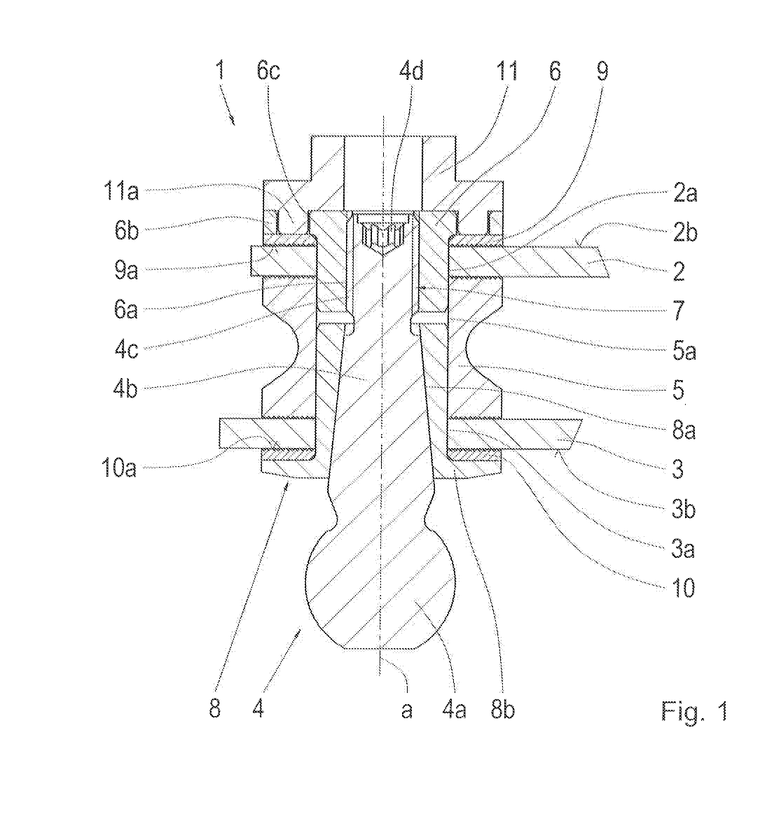

FIG. 1 shows an inventive screw connection 1 between a double-walled structure, comprising a first wall 2 as well as a second wall 3, and a load-introducing element 4, designed as a metallic ball stud 4. The first wall 2 and the second wall 3 of the double-walled structure are designed with a fiber-plastic-composite (FPC) which is manufactured with long or endless fibers and a matrix component of an artificial resin. The fibers create hereby a textile, for instance a fabric with a load matching alignment of the fibers. Such FPC structures are known from the state of the art whereby partially also the designation fiber-composite-plastic (FPC) is common. The double-walled structure 2, 3, only partially shown, is part of a larger component into which forces from another, unillustrated, component are induced through the load-introducing element 4. The ball stud 4 has a longitudinal axis a, ball head 4a, conical shaft 4b, as well as an outer thread 4c. The first wall 2 has a recess 2a and the second wall 3 has a recess 3a. A spacer 5 is positioned between the first wall 2 and the second wall 3 and has, coaxial to the longitudinal axis a, a through hole 5a. A threaded sleeve 6 is inserted into the recess 2a of the first wall 2, and has an inner thread 6a and a collar 6b. The outer thread 4c of the ball stud 4 is screwed to the inner thread 6a of the threaded sleeve 6 and forms a threaded section 7. A cone sleeve 8 inserted into the recess 3a of the second wall 3 and extends with its cylindrical shaft into the through hole 5a of the spacer 5. The conical sleeve 8 has an inner cone 8a and a flange 8b. The cone shaped shaft 4b or outer cone 4b is placed free of play in the inner cone 8a and is kept there friction-fit. The first wall 2 has an outer surface 2b, also called the outer contour 2b, and the second wall 3 has an outer surface 3b, also called outer contour 3b. Directly at the outer surface 2b is a first disc 9 positioned with a micro-toothed surface 9a, while at the outer surface 3b of the second wall 3a, a second disc 10 is positioned with a micro-toothed surface 10a. The first and the second discs 9, 10 are metal discs, their micro-toothed surfaces 9a, 10a grab into the plastic surfaces 2b, 3b and therefore increase the friction coefficient. This effect is known from the previously mentioned documentation “Konstruktion 2013”, page 62-66. In the collar 6b which is placed on the first disc 9 are, distributed across the perimeter, bores 6c positioned into which studs 11a of an installation tool 11 engage. At the front end of the ball stud 4 is a blind hole 4d positioned with a polygon cross-section, Allen or hexagonal socket, into which an appropriate installation tool (Allen wrench) can be inserted.

For the creation of a force loadable screw connection, the ball stud 4 and the rotatably positioned threaded sleeve 6 are screwed together through the threaded section 7 and tensioned, wherein the tightening torque is applied by the installation tool 11 and the holding torque by the inner hexagon 4d. The thus created biasing and tensile force in the direction of the longitudinal axis a now cause the micro-toothed surfaces 9a, 10a to press into the outer surfaces 2b, 3b. The first wall 2 is supported with respect to the second wall 3 by the spacer 5 which can be made from metal or plastic. Lateral forces, meaning substantially perpendicular to the longitudinal axis a of the FPC structure 2, 3, are here introduced by way of the ball head 4a, meaning that the structure 2, 3 is loaded with a torque. This loading torque is accommodated through a couple of forces comprising friction forces which are present in the planes of the outer surfaces 2a, 2b. Thus, there is a relatively low load for the double-walled structure 2, 3. As it can be seen from the drawing, the threaded section 7 is essentially, that is to say a large portion thereof, positioned within the outer contour 2b, meaning that only at relatively small portion of the threaded section 7 and the threaded sleeve 6 extend beyond the outer contour 2b. The fastening of the load-introducing element 4 is therefore essentially positioned within the double-walled structure 2, 3, meaning their outer contours 2b, 3b.

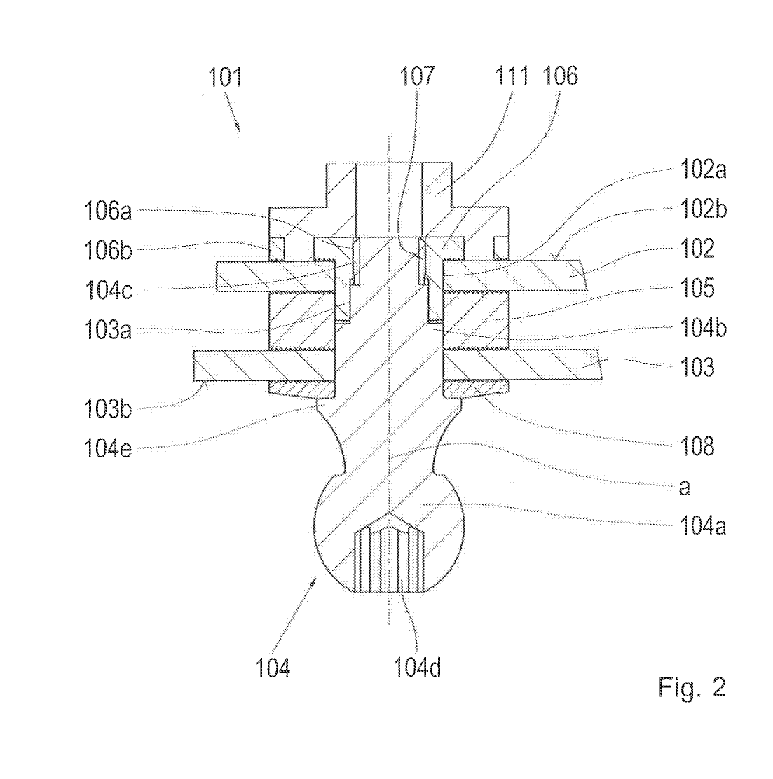

FIG. 2 shows a second embodiment of the invention for the inventive screw connection 101, wherein the same or analogous elements as shown in FIG. 1 are marked with the same reference numbers but are increased by 100. The screw connection 101 comprises a double-walled FPC structure of a first wall 102 and a second wall 103 with a spacer 105 positioned therebetween. A threaded sleeve 106 is inserted into the recess 102a, while a ball stud 104 with a cylindrical shaft 104b is inserted into the recess 103a, The ball stud 104 has a collar 104e which is supported on a disc 108 which is arranged at the outer surface 103b of the second wall 103. The ball stud 104 has at its end facing away from the ball head 104a an outer thread 104c which is screwed into the inner thread 106a of the threaded sleeve 106. Into the collar 106b of the threaded sleeve 106—analogous to the first embodiment—a mounting tool engages which removed after assembly of the screw connection. The threaded section 107 which connects the ball stud 104 to the threaded sleeve 106, extends very little at the outer surface 102b of the first wall 102. The load torque which is introduced by way of the ball head 104a is also transferred friction-fit and form-fit in this screw connection 101, wherein the friction forces are present at the outer surfaces 102b, 103b and the form fit is active throughout the perimeter of the threaded sleeve 106 in the recess 102a and the cylindrical shaft 104b of the ball stud 104 in the recess 103a.

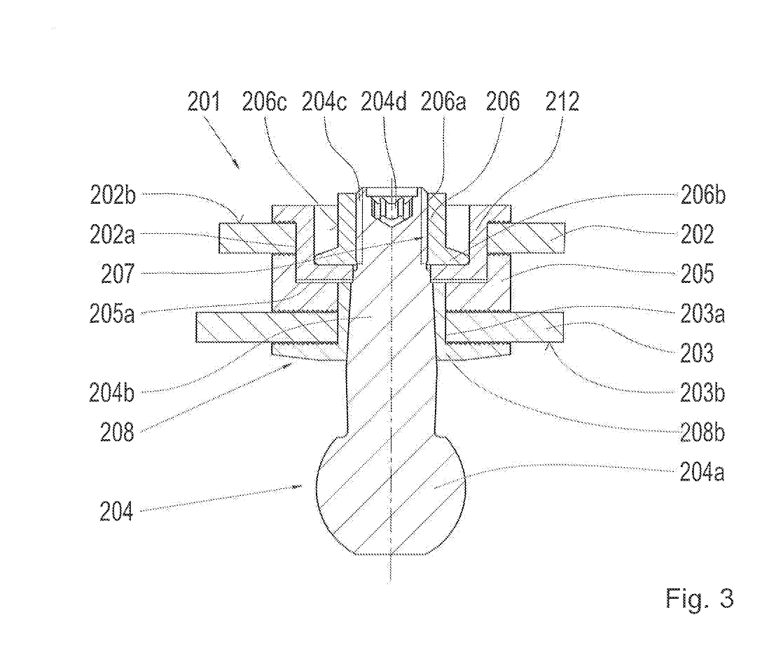

FIG. 3 shows a third embodiment of the invention for a screw connection 201 whereby for identical or analogous elements as shown in FIG. 1 are marked with the same reference numbers but are increased by 200. A spacer 205 with a stepped bore 205a is positioned between the first and the second wall 202, 203 which is made from a fiber-plastic-composite (FPC). Into the wider part of the stepped bore 205a extends a collar sleeve 212 which is positioned in the recess 202a of the first wall 202. In the collar sleeve 212 is an embedded nut 206 positioned which has an inner thread 206a and a flange 206b which is place on the collar sleeve 212. Screwed into the countersunk nut 206 is the end of the ball stud 204 with its outer thread 204c and forms threaded section 207. The countersunk nut 206 has preferably hexagonal surfaces 206c at its outer perimeter in which a torque tool can be attached for pretensioning. The ball stud 204 has at its front a blind hole with an inner hexagon or hexalobular 204d for the application of a torque tool. The conical shaft 204b of the ball stud 204 resides in the inner cone of the conical sleeve 208 which is arranged with its collar 208b on the outer surface 203b of the second wall 203. The ball stud 204 is pre-tensioned by the countersunk nut 206 where the pretension is supported by the collar sleeve 212 and the outer surface 202b of the first wall 202. The load torque which is introduced by the ball head 204a is transmitted in this embodiment as friction-fit and form-fit to the FPC structure 202, 203.

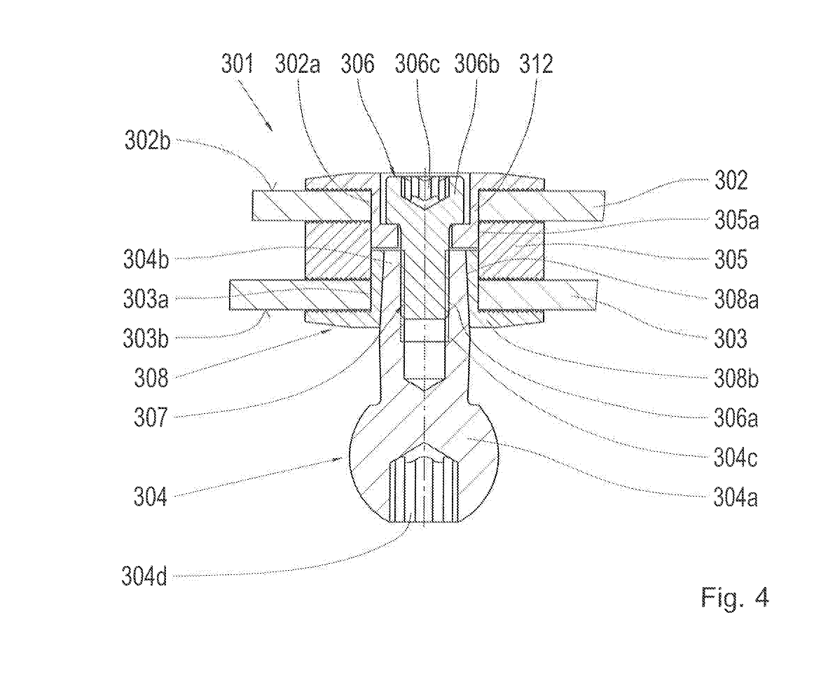

FIG. 4 shows a fourth embodiment example of the invention for a screw connection 301, whereby same or analogue parts, as in the first embodiment have the same reference numbers but are increased by 300. A spacer 305 with a through hole 305a is positioned between the double-walled FPC structure having a first wall 302 and a second wall 303. A collar sleeve 312 is placed into the recess 302a of the first wall 302, which is supported at the outer surface 302b of the first wall 302. Into the stepped bore of the collar sleeve 312, a cylinder head screw 306 is placed which has an outer thread 306a, a screw head 306b, and an hexagon socket 306c, which means that the screw head 306b is countersunk with respect to the first wall 302. A conical sleeve 308 is placed into the recess 303a of the second wall 303, which is supported with its collar 308b in reference to the outer surface 303b of the second wall 303. The inner cone 308a of the cone sleeve 308 receives with friction-fit the cone shaft 304b of the ball stud 304. The ball stud 304 has a blind hole with an inner thread 304c into which the outer thread 306a of the cylinder head screw 306 is screwed in that forms the threaded section 307, through which the ball stud 304 is tensed with the cylinder head screw 306. The ball stud 304, as well as the cylinder head screw 306, each have a hexagonal socket 304d or 306c, respectively, to apply a torque tool (Allen Key). The load torques which are injected in the ball head 304a—as explained above—are friction-fit and form-fit injected in the FPC structure 302, 303.

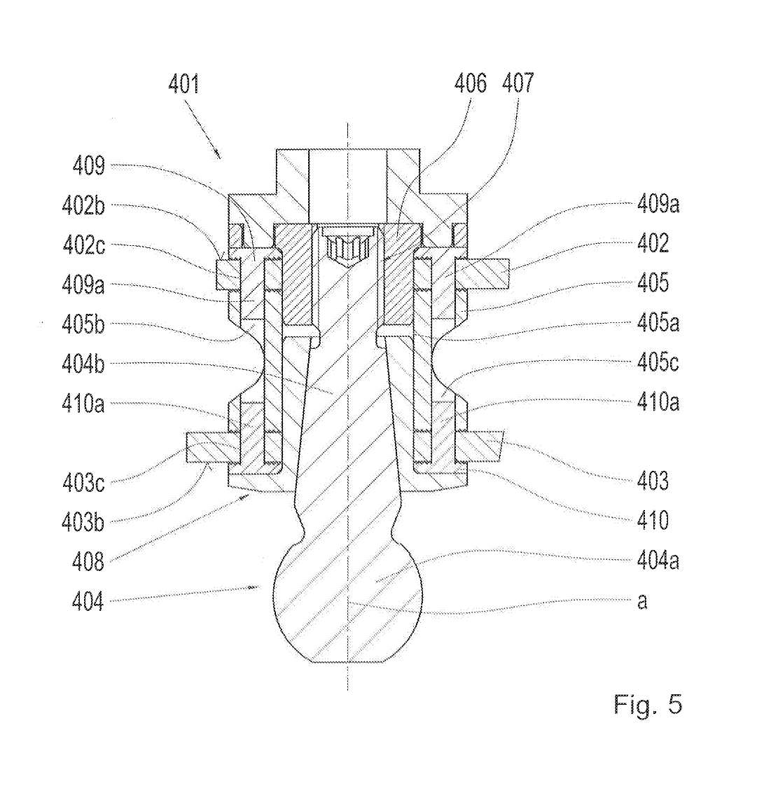

FIG. 5 shows a fifth embodiment of the invention for a screw connection 401 which is a continuation of the first embodiment example in accordance with FIG. 1. Same reference numbers are used for the same or analogous parts, but are increased by 400. Positioned between the first wall 402 and the second wall 403, both manufactured with a fiber-plastic composite, is a spacer 405 with a through hole 405a that is concentric with longitudinal axis a of the ball stud 404 and which has bores distributed at the perimeter 405b, 405c. At the outer surfaces 402b, 403b of the first and of the second wall 402, 403 a first disc 409 and a second disc 410 are positioned each having, parallel to the longitudinal axis a, inserted pins 409a, 410a, distributed about the perimeter. Supplemental bores 402c, 403c are positioned in the first wall 402 and in the second wall 403 which align with the perimeter bores 405b, 405c, and which are penetrated by the pins 409a, 410a. Hereby, an improvement of the form-fit during the transfer of lateral forces to the FPC structure is achieved. At the same time, the bearing pressure on the projected surface perpendicular to the longitudinal axis a of the recesses 402a, 403a and the supplemental bores 402c, 403c is reduced. Both disks 409, 410 are tensioned against each other through the threaded sleeve 406 and the ball stud 404 which are screwed together through the threaded section 407. Lateral forces and load torques which are introduced by way of the ball head 404a are on one hand transferred via the friction-fit, but also transferred to the FPC structure 402, 403 by a stronger form-fit.

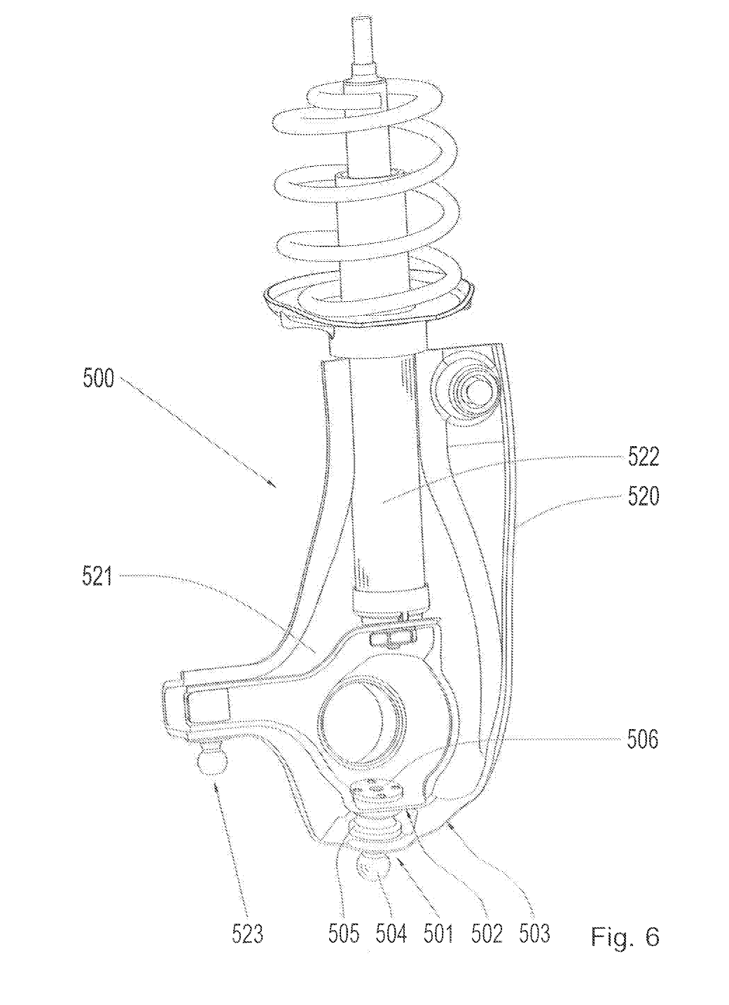

FIG. 6 shows as an additional embodiment of the invention, an advantageous application of the inventive screw connection 501 in a wheel carrier 500 for motor vehicles. The wheel carrier 500 is made from fiber-plastic-composite construction and designed as two-shell part, meaning it has an outer shell 520 and an inner shell 521. A spring strut 522 is attached at the wheel carrier 500 and which supports, here not shown, the chassis of a vehicle. The wheel carrier 500 corresponds in particular to the wheel carrier as it has been described in the older application of the applicant with the official file number 10 2013 209 987.8—the content of the earlier application, as mentioned above, is fully incorporated by reference into the disclosure of the present application. In regard to the inventive screw connection 501, the inner shell 521 corresponds to the first wall 502, and the outer shell 520 corresponds to the second wall 503; the screw connection 501 is installed, in accordance with the invention, at this two-shell structure. One recognizes in the drawing the downward pointing ball stud 504, the spacer 505 which is positioned between the first wall 502 and the second wall 503 and, above the first wall 502 (inside of the inner shell 521), the collar of the threaded sleeve 506. At the ball head of the ball stud 504 has preferably a transverse control arm attached through which transverse loads or a load torque, respectively, are introduced in the FPC structure of the wheel carrier 500. An additional screw connection with a ball stud 523 serves as a linkage with a not shown tie rod.

### REFERENCE CHARACTERS

1 101, 201, 301, 401 501 Screw Connection
2 102, 202, 302, 402, 502 First Wall
2a 102a, 202a, 302a, 402a Recess
2b 102b, 202b, 302b, 402b Outer Surface
3. 103, 203, 303, 403, 503 Second Wall
3a 103a, 203a, 303a, 403a Recess
3b 103b, 203b, 303b, 403b Outer Surface
4. 104, 204, 304, 404, 504 Load-introducing Element, Ball Stud
4a 104a, 204a, 304a, 404a Ball Head
4b 104b, 204b, 304b, 404b Cylindrical / Conical Shaft
4c 104c, 204c Outside Thread
4d 104d, 204d, 304d Inside Hex Socket
5 105, 205, 305, 405, 505 Spacer
5a 305a, 405a Through Hole
6 106, 406, 506 Holding element
6a 106a, 206a Inside Thread
6b 106b Collar
6c Bore, Recess
7 107, 207, 307, 407 Thread Section
8 208, 308, 408 Conical Sleeve
8a 208a, 308a Inner Cone
8b 208b, 308b Collar
9 409 First Disc
9a Micro-toothed Surface
10 410 Second Disc
11 111 Installation Tool
11a Stud
104e Collar
108 Disc
205a Stepped Bore
206 Countersunk nut
206b Flange
206c Hex Surfaces
212 Collar Sleeve
304c Inside Thread
305a Through Hole
306 Cylindrical Head Screw
306a Outside Thread
306b Screw Head
306c Inner Hex Socket
312 Wall Sleeve
402c, 403c Supplemental Bore
405a Through Hole
405b 405c Circumferential Bore, Recess
409a, 410a Pin
500 Wheel Carrier
520 Outer Shell
521 Inner Shell
522 Spring Strut
523 Ball Stud
a Longitudinal Axis/Ball Stud

1-18. (canceled)

19. An arrangement for connecting chassis components between a structure made of a fiber-plastic-composite (FPC) and a metallic, load-introducing element (4, 104, 204, 304, 404),
the structure being multi-walled having a first wall (2, 102, 202, 302, 402) and at least one additional wall (3, 103, 203, 303, 403) being spaced from the first wall;
the first wall and the additional wall each having at least one recess (2a, 3a, 102a, 103a, 202a, 203a, 302a, 303a, 402a, 403a) that are positioned coaxially with respect to one another;
a spacer (5, 105, 205, 305, 405), having a through hole (5a, 305a, 405a), being positioned between the first wall and the additional wall;
the load-introducing element (4, 104, 204, 304, 404) being held extending through the through hole (5a, 305a, 405a) of the spacer (5, 105, 205, 305, 405) and the at least one recess (2a, 3a) of at least one of the first wall and the additional wall;
the load-introducing element (4, 104, 204, 304, 404) having a corresponding holding part (6, 106, 206, 306, 406);
the load-introducing element (4, 104, 204, 304, 404) and the holding part (6, 106, 206, 306, 406) being connected with one another by a connection section (7, 107, 207, 307, 407) by at least one of a form-fit, a force-fit and a material-fit; and
the connection section (7, 107, 207, 307, 407) and the holding part (6, 106, 206, 306, 406) essentially extending through at least one of the first wall and the at least one additional second wall (2, 102, 202, 302, 402; 3, 103, 203, 303, 403).

20. The arrangement for connecting chassis components according to claim 19, wherein the holding part is one of a threaded sleeve (6, 106, 406), a countersunk nut (206) and a countersunk cylinder head screw (306).

21. The arrangement for connecting chassis components according to claim 19, wherein the load-introducing element is a ball stud (4, 104, 204, 304, 404).

22. The arrangement for connecting chassis components according to claim 21, wherein the ball stud (4, 204, 304, 404) either has an essentially conical shaft (4b, 204b, 304b, 404b) or a cylindrical shaft (104b).

23. The arrangement for connecting chassis components according to claim 22, wherein the ball stud (4, 204, 304, 404), with the essentially conical shaft (4b, 204b, 304b, 404b) or the cylindrical shaft (4b, 104b, 204b, 304b, 404b), is supported in a conical sleeve (8, 208, 308, 408), which extends through the additional wall in the recess (3a, 103a, 203a, 303a, 403a), by either a friction-fit or a force-fit.

24. The arrangement for connecting chassis components according to claim 19, wherein the holding part is either a threaded sleeve (6, 106, 406) or countersunk nut (206) having an inner thread (6a, 106a, 206a, 406a), the load-introducing element is a ball stud (4, 104, 204, 404) having an outer thread (4a, 104a, 204a, 404a), and the inner thread and the outer thread form the connection section (7, 107, 207, 407).

25. The arrangement for connecting chassis components according to claim 19, wherein in the load-introducing element is a ball stud (4, 104, 204, 304, 404) which has a blind hole (4d, 104d, 204d, 304d) with a polygon cross-section which receives an installation tool.

26. The arrangement for connecting chassis components according to claim 19, wherein the holding part (6, 106) is a threaded sleeve having a collar (6b, 106b) which is either directly or indirectly on supported the first wall (2, 102).

27. The arrangement for connecting chassis components according to claim 19, wherein the holding part (206) is a countersunk nut that is supported by a collar sleeve (212) with respect to the first wall (202).

28. The arrangement for connecting chassis components according to claim 20, wherein the holding part (306) is the countersunk cylinder head screw which has an outer thread (306a), and the load-introducing element is a ball stud having an inner thread (304c), and the inner thread and the outer thread form the connection section (307).

29. The arrangement for connecting chassis components according to claim 28, wherein cylinder head screw (306) is supported at the first wall (302) by a collar sleeve (312).

30. The arrangement for connecting chassis components according to claim 26, wherein a disc (9), having a micro-toothed surface (9a), is positioned between the collar (6b) of the holding part, in the form of the threaded sleeve (6), and the first wall (2).

31. The arrangement for connecting chassis components according to claim 23, wherein the conical sleeve (8, 208, 308, 408) has a collar (8b, 208b, 308b, 408b) which is supported either, directly or indirectly, at the at least one additional wall (3, 203, 303, 403).

32. The arrangement for connecting chassis components according to claim 31, wherein a disc (10), having a micro-toothed surface (10a), is positioned between the collar (8b) and the at least one additional wall (3).

33. The arrangement for connecting chassis components according to claim 30, wherein the disc (409, 410) with the micro-toothed surface has pins (409a, 410a) that are positioned about a perimeter of the micro-toothed surface and that engage, via a form-fit, with the recesses (402c, 403c, 405b, 405c) of at least one of the first wall, the at least one additional wall (402, 403) and the spacer (405).

34. The arrangement for connecting chassis components according to claim 33, wherein the collar (6b, 106b) of the threaded sleeve (6, 106) has apertures (6c) arranged about a circumference thereof that are positioned to operate with an installation tool (11, 111).

35. The arrangement for connecting chassis components according to claim 33, wherein the collar (6b, 106b) of the threaded sleeve (6, 106) has recesses (6c) arranged about a periphery thereof for engagement with an installation tool.

36. A wheel carrier for a motor vehicle with at least a double-walled structure made of a fiber-plastic-composite (FPC), a first wall (502) being designed as an inner shell (521) and at least one additional second wall (503) designed as an outer shell (520) and being spaced from the first wall;
a metallic load-introducing element (501, 523) being installed at the first wall and the second wall (502, 503) by an arrangement for connecting chassis parts (505, 505, 506);
the first wall and the second wall each having coaxially positioned recesses (2a, 3a, 102a, 103a, 202a, 203a, 302a, 303a, 402a, 403a);
a spacer (5, 105, 205, 305, 405), having a through hole (5a, 305a, 405a), being positioned between the first wall and the second wall;
the load-introducing element (4, 104, 204, 304, 404) having at least one recess (2a, 3a, 102a, 103a, 202a, 203a, 302a, 303a, 402a, 403a) and extending through the through hole (5a, 305a, 405a) of the spacer (5, 105, 205, 305, 405);
the load-introducing element (4, 104, 204, 304, 404) having a holding part (6, 106, 206, 306, 406);
the load-introducing element (4, 104, 204, 304, 404) and the holding part (6, 106, 206, 306, 406) being connected with one another by a connection section (7, 107, 207, 307, 407) formed as at least one of a form-fit, a force-fit and a material-fit; and
the connection section (7, 107, 207, 307, 407) and the holding part (6, 106, 206 306, 406) extending through at least one of the first wall and the at least one second wall (2, 102, 202, 302, 402; 3, 103, 203, 303, 403).

37. An arrangement for connecting vehicle chassis components between a fiber-plastic-composite structure and a metallic, tensile load-introducing element;
the fiber-plastic-composite structure having first and second walls;
each of the first wall and the second wall having at least one recess;
the first and the second walls being arranged with respect to one another such that the recess of the first wall being coaxially aligned with the recess of the second wall;
a spacer being positioned between the first and the second walls to separate the first wall from the second wall by a distance;
the spacer having a through hole and being arranged such that the through hole of the spacer being coaxially aligned with the recesses of the first and the second walls;
a retaining member extending through the recess in the first wall and the tensile load-introducing element extending through the recess in the second wall, and
the retaining member engaging the tensile load-introducing element by at least one of a form-fit, a force-fit and a material-fit and forming a connecting portion.
